(19) United States
(12) Patent Application Publication
(10) Pub. No.: US 2024/0016184 A1
(43) Pub. Date: Jan. 18, 2024

(54) MEAT SUBSTITUTE PRODUCT

(71) Applicant: CARGILL, INCORPORATED, Wayzata, MN (US)

(72) Inventors: Beatrice Ines FELKE, Hamburg (DE); Zuzana VAN BEVEREN, Hombeek (BE)

(73) Assignee: CARGILL, INCORPORATED, Wayzata, MN (US)

(21) Appl. No.: 18/254,304

(22) PCT Filed: Nov. 17, 2021
(86) PCT No.: PCT/US2021/059689

§ 371 Date: May 24, 2023

(30) Foreign Application Priority Data
Nov. 24, 2020 (EP) 20209360.5

(51) Int. Cl. A23J 3/22; A23J 3/14; A23L 29/00; A23K 50/40; A23K 20/147; A23K 20/158; C11C 3/10

(52) U.S. Cl. CPC A23J 3/227; A23J 3/14; A23L 29/04; A23K 50/40; A23K 20/147; A23K 20/158; C11C 3/10

(57) ABSTRACT

The present invention relates to a meat substitute product comprising a randomly interesterified triglyceride and at least one texturized protein ingredient, wherein the randomly interesterified triglyceride has a content of palmitic acid (C16) and stearic acid (C18) in a range of from 35 to 65 wt %, and a ratio of C18 over C16 in a range of from 1.0 to 15.0. The invention further relates to the use of the corresponding randomly interesterified triglyceride for improving the texture and/or organoleptic properties of a ground meat substitute product. Preferably the meat substitute product is a vegetarian ground meat substitute product that is shaped into a form such as a burger, a patty, a meatball, a nugget or a sausage.

### CROSS-REFERENCE TO RELATED APPLICATIONS

This application claims the benefit of European Application No. 20209360.5, filed 24 Nov. 2020, which is incorporated by reference herein in its entirety.

### FIELD OF THE INVENTION

The present invention relates to a meat substitute product comprising a randomly interesterified triglyceride and at least one texturized protein ingredient. The invention further relates to the use of a randomly interesterified triglyceride for improving the appearance, texture and/or organoleptic properties of a ground meat substitute product. Preferably the meat substitute product is a vegetarian ground meat substitute product that is shaped into a form such as a burger, a patty, a meatball, a nugget or a sausage.

### BACKGROUND OF THE INVENTION

Traditionally, meat products have taken an important place in our western diet. Meat products are consumed in many different forms as whole muscle or minced pieces of meat that are cooked, grilled, smoked, cured or fermented in form of hamburgers, patties, sausages, meat balls, nuggets and many more.

There is a growing consumer trend for reducing or completely removing these animal products from their diet. Consumers switch towards plant-based meat substitutes because of various reasons such as health concerns, environmental concerns, sustainability or animal welfare.

In order for a regular meat consumer to be motivated to choose for meat substitutes, it is critical that these substitutes mimic the fibrous qualities provided by animal muscle fiber. The meat substitutes should resemble meat products in terms of appearance and texture during and after cooking. They should mimic organoleptic properties, like appearance, flavor, bite, succulence and mouthfeel when being consumed.

Various functional ingredients in meat substitutes are required to mimic the taste, flavor, texture, mouthfeel and appearance of meat-based products.

There is still a need to improve the appearance, texture and/or organoleptic properties of meat substitutes and more specifically of ground meat substitutes. The present invention provides such a solution.

### SUMMARY OF THE INVENTION

The present invention relates to a meat substitute product comprising a randomly interesterified triglyceride and at least one texturized protein ingredient, wherein the randomly interesterified triglyceride has a content of palmitic acid (C16) and stearic acid (C18) in a range of from 35 to 65 wt %, and a ratio of C18 over C16 in a range of from 1.0 to 15.0.

The invention further relates to the use of a randomly interesterified triglyceride having a content of palmitic acid (C16) and stearic acid (C18) in a range of from 35 to 65 wt %, and a ratio of C18 over C16 in a range of from 1.0 to 15.0, for improving the appearance, texture and/or organoleptic properties of a ground meat substitute product.

### DETAILED DESCRIPTION

The present invention relates to a meat substitute product comprising a randomly interesterified triglyceride and at least one texturized protein ingredient, wherein the randomly interesterified triglyceride has a content of palmitic acid (C16) and stearic acid (C18) in a range of from 35 to 65 wt %, and a ratio of C18 over C16 in a range of from 1.0 to 15.0.

Meat substitute products are food or feed compositions that mimic animal processed whole-muscle meat products as well as processed restructured meat products such as burgers, patties, sausages and the like. Methods of processing may be salting, chopping, fermentation, boiling, smoking, extrusion or other processes.

Meat substitute products can be divided into ground, also called minced, products and fine paste products. Ground meat substitute products are coarse-particle products such as alternatives for burgers, patties, sausages, meatballs, nuggets and the like. Fine paste products are typically emulsified products such as alternatives for frankfurter, bologna, mortadella and the like.

In one aspect of the invention, the meat substitute product is a ground meat substitute

The ground meat substitute product may be shaped in a form, such as the form of a burger, a patty, a meatball, a nugget or a sausage. In a preferred aspect of the invention, the meat substitute product is a ground and shaped meat substitute.

In another aspect of the invention, the ground meat substitute product is a ground vegetarian protein product. The ground vegetarian protein product is not based on meat or fish. More preferably the ground meat substitute product is a ground vegan protein product. The ground vegan protein product is not based on products derived from animals. Examples of products derived from animals are amongst others meat, fish, eggs, milk or honey.

The meat substitute product of the present invention is typically designed for consumption after cooking.

Alternatively, the meat substitute product of the present invention is a pet food. The term “pet food” means any food composition intended to be consumed by a pet. A pet may be any domestic or tamed animal kept for companionship or pleasure. For example, the pet can be an avian, bovine, canine, equine, feline, hircine, lupine, murine, ovine, or porcine animal. Preferably, the pet is a dog or a cat.

The meat substitute product of the present invention is comprising a randomly interesterified triglyceride, which is a triglyceride composition wherein the fatty acids are randomly distributed over the glycerol backbone of the triglycerides.

The randomly interesterified triglyceride can be obtained by means of a process of chemical or enzymatic interesterification.

A chemical interesterification is performed by using an acidic or basic catalyst, preferably a basic catalyst, such as, but not limited to, sodium methoxide or sodium ethoxide. An enzymatic interesterification is obtained by means of a lipase enzyme. The lipase will generally be non-selective for the positions on the glyceride backbone in order to achieve the optimum random interesterification. Alternatively, selective lipases may be used, provided that the reaction conditions are such that no significant selectivity is observed, for example by running the reaction for extended periods of time. Suitable lipases include the lipases from Thermomyces lanuginosa, Rhizomucor miehei, Rhizopus delemar and Candida rugosa. Preferably, the lipase is suitable for use with food products.

It may be that the interesterification is not fully random, but it is preferably random to a large extent, for example greater than 75%, greater than 85%, preferably greater than 95% of the fatty acid residues may change position during the reaction i.e. less than 25%, less than 15%, preferably less than 5% of the fatty acids retain their original position of the starting triglyceride.

The interesterified triglyceride may be characterized by the position of the saturated (S) and/or unsaturated (U) fatty acids bound onto the glycerol backbone of the triglyceride.

Typically, the abbreviation S is used to denote a saturated fatty acid residue having 12 to 24 carbon atoms. The abbreviation U denotes an unsaturated fatty acid residue having 12 to 24 carbon atoms. Thus, a triglyceride having saturated fatty acids at the 1- and 3-positions and an unsaturated fatty acid at the 2- position of the glycerol backbone is denoted SUS. Likewise, a triglyceride having 2 saturated fatty acids at the 1- or 3- position and at the 2- position of the glycerol backbone and an unsaturated fatty acid at the remaining 1- or 3-position is denoted SSU.

The ratio of SUS over SSU (SUS/SSU) of a fully randomized triglyceride composition is 0.5, whereas the SUS/SSU ratio of a non-randomized triglyceride is significantly higher than 1.

In one aspect of the invention, the triglyceride composition of the randomized triglyceride is characterized by a ratio of SUS over SSU (SUS/SSU) in a range of from 0.5 to 1.0, from 0.6 to 0.9, or from 0.7 to 0.8.

In another aspect of the invention, the randomly interesterified triglyceride is obtained by means of a chemical interesterification.

The randomly interesterified triglyceride has a content of palmitic acid (C16) and stearic acid (C18) in a range of from 35 to 65 wt %, from 38 to 55 wt %, from 40 to 50 wt %, or from 42 to 45 wt %. The ratio of C18 over C16 is in a range of from 1.0 to 15.0, from 1.1 to 10.0, or from 1.2 to 8.0.

The saturated fatty acids of the randomly interesterified triglyceride are sourced from triglycerides such as, but not limited to, palm oil, cocoa butter, shea butter, shea stearin, shea olein, coconut oil, palm kernel oil, liquid oils such as sunflower oil, rapeseed oil, cottonseed oil or soybean oil, or any combination of two or more thereof. The triglycerides may be hydrogenated and/or fractionated. Palm oil is encompassing palm oil, as well as palm oil fractions such as stearin and olein fractions (single as well as double fractionated), palm mid fractions and blends of palm oil and/or its fractions.

In another aspect of the invention, the content of lauric acid (C12) in the randomly interesterified triglyceride is less than 5.0 wt %, less than 3.0 wt %, or even less than 1.0 wt %.

The saturated fatty acids of the randomly interesterified triglyceride are sourced from non-lauric triglycerides such as, but not limited to palm oil, cocoa butter, shea butter, shea stearin, shea olein, liquid oils such as sunflower oil, rapeseed oil, cottonseed oil or soybean oil, or any combination of two or more thereof. Examples of lauric triglycerides are coconut oil and palm kernel oil. The non-lauric triglycerides may be hydrogenated and/or fractionated.

Preferably the fatty acids of the randomly interesterified triglyceride are not sourced from palm. Example of fatty acids sourced from palm are palm oil, palm oil fractions, palm kernel oil, palm kernel oil fractions or any combination of two or more thereof.

Preferably the fatty acids of the randomly interesterified triglyceride are not sourced from hydrogenated triglycerides.

In one more aspect of the invention, the randomly interesterified triglyceride has a content of oleic acid (C18.1) and linoleic acid (C18.2) in a range of from 35 to 60 wt %, from 40 to 58 wt %, or from 45 to 55 wt %.

In yet another aspect of the invention, the randomly interesterified triglyceride has a melting point in a range of from 35 to 65° C., from 38 to 55° C., or from 40 to 50° C. The melting point can be determined according to the official AOCS method Cc 3-25.

In a preferred aspect of the invention, the randomly interesterified triglyceride has:
a content of C16+C18 in a range of from 35 to 65 wt %, from 38 to 50 wt %, from 40 to 45 wt %, and
a ratio of C18 to C16 of from 1.0 to 1.5, from 1.1 to 1.4,
an SUS/SSU ratio in a range of from 0.5 to 1.0, from 0.6 to 0.9, or from 0.7 to 0.8, and wherein the fatty acids from the randomly interesterified triglyceride are not sourced from palm and/or hydrogenated triglycerides.

In a more preferred aspect of the invention, the randomly interesterified triglyceride has:
a content of C16+C18 in a range of from 35 to 65 wt %, from 38 to 50 wt %, from 40 to wt %, and
a ratio of C18 to C16 of from 1.0 to 1.5, from 1.1 to 1.4, and
a content of C12 of less than 5.0 wt %, less than 3.0 wt %, or even less than 1.0 wt %, and
a content of C18.1+C18.2 in a range of from 35 to 60 wt %, from 40 to 58 wt %, or from 45 to 55 wt %,
an SUS/SSU ratio in a range of from 0.5 to 1.0, from 0.6 to 0.9, or from 0.7 to 0.8, and wherein the fatty acids from the randomly interesterified triglyceride are not sourced from palm and/or hydrogenated triglycerides.

In another aspect of the invention, the randomly interesterified fat is present in the meat substitute product in an amount of from 1.0 to 18.0 wt %, from 2.0 to 15.0 wt %, from 4.0 to 12.5 wt %, or from 6.0 to 10.0 wt % on the total weight of the meat substitute product.

In one more aspect of the invention, the meat substitute product has a total triglyceride content in a range of from 2.0 to 25.0 wt %, from 4.0 to 21.0 wt %, from 7.0 to 18.0 wt %, or from 10.0 to 15.0 wt % on the total weight of the meat substitute product. The total triglyceride content of the meat substitute product is comprising the randomly interesterified triglyceride. The total fat content of the meat substitute product may further comprise other triglycerides such as, but not limited to, palm oil and palm oil fractions such as palm oil stearin or palm oil olein, cocoa butter, shea butter, shea stearin, shea olein, liquid oils such as sunflower oil, rapeseed oil, cottonseed oil or soybean oil, hydrogenated liquid oils, or any combination of two or more thereof.

In one aspect of the invention, the meat substitute product is further comprising a liquid oil in a range of from 1.0 to 7.0 wt %, from 2.0 to 6.0 wt %, from 3.0 to 5.5 wt %, from 4.0 to 5.0 wt % on the total weight of the meat substitute product.

The term “liquid oil” is defined as triglycerides with a melting point of less than 20° C. The liquid oil can be one liquid oil or a blend of more than one liquid oils. In case of a blend of liquid oils, it is understood that the blend of the more than one liquid oil has a melting point of less than 20° C.

The “liquid oil” is a vegetable oil.

Examples of vegetable liquid oils are amongst others double fractionated palm olein, cottonseed oil, corn oil, groundnut oil, linseed oil, olive oil, rapeseed oil, rice bran oil, sesame oil, safflower oil, soybean oil, sunflower oil, oil from any variety of oilseeds with increased level of unsaturated fatty acids compared to the original seed variety, such as mid or high oleic sunflower oil. These varieties with increased levels of unsaturated fatty acids can be obtained by natural selection or by genetic modification (GMO). Preferably, the vegetable oil is selected from the group consisting of cottonseed oil, corn oil, groundnut oil, linseed oil, olive oil, rapeseed oil, rice bran oil, sesame oil, safflower oil, soybean oil, sunflower oil, their corresponding high oleic varieties, and mixture of two or more thereof. More preferably, the vegetable oil is selected from the group consisting of corn oil, rapeseed oil, soybean oil, sunflower oil, their corresponding high oleic varieties, and mixture of two or more thereof. The high oleic varieties are containing at least 40%, at least 50%, at least 60%, at least 70% and preferably at least 80% oleic acid in respect of the fatty acid profile.

In a preferred aspect of the invention, the meat substitute product comprises substantially no oils sourced from palm. Certain consumers prefer food and/or feed products without oils sourced from palm, such as palm oil, palm oil fractions, palm kernel oil, palm kernel oil fractions or a combination of two or more thereof. Therefore, the meat substitute product according to the present invention can offer an alternative to products containing oils sourced from palm.

In another preferred aspect of the invention, the meat substitute product comprises substantially no hydrogenated triglycerides.

The meat substitute product also comprises at least one texturized protein ingredient.

A texturized protein is a fibrous protein product. It may enhance the textural and sensorial quality of the meat substitute product. It may influence the bite, succulence and/or moistness of the meat substitute product.

Preferably the at least one texturized protein ingredient is from a vegetable source, i.e. a texturized vegetable protein. A texturized vegetable protein is a processed vegetable product usually made from high protein flour or its protein concentrate through an extrusion process at high temperature and pressure to produce a fibrous, insoluble and porous product. The at least one texturized vegetable protein is sourced amongst others from soy, pea, corn, cottonseed, wheat, sunflower seed, oats or combinations of two or more thereof. More preferably, the at least one texturized protein ingredient is sourced from soy, pea, wheat, sunflower, or mixtures of two or more thereof. More preferably, the at least one texturized protein ingredient is texturized soy protein and/or texturized pea protein.

In one aspect of the invention, the at least one texturized protein ingredient is present in the meat substitute composition in an amount if from 10 to 25%, from 12 to 22%, or from 15 to 20%, expressed as dry weight on total weight of the meat substitute composition.

In another aspect of the invention, the meat substitute product further comprises water. The total amount of water is in a range of from 40 to 80 wt %, from 50 to 75 wt %, or from 60 to 70 wt % on the total weight of meat substitute product. The total amount of water refers to the added amount of water as well as the amount of water that is used to hydrate the texturized protein ingredient. Hydration of the texturized protein ingredient may typically be done in a ratio of 1 part of dry texturized protein ingredient on 2 up to 5 parts of water. Typically, the water can be used for dispersing of binding and texturizing ingredients.

In one more aspect of the invention, the meat substitute product also comprises a further protein ingredient which is not texturized. This protein ingredient may be present in the meat substitute product for providing good emulsification, protein enrichment, elasticity, gelation and/or water binding effect. This protein ingredient may be from plants, fungi, algae, insects, animals or a mixture of two or more thereof. Examples of animal protein ingredients are egg protein, dairy products such as whey or casein, or combinations of two or more thereof. Examples of plant proteins are amongst others soy, wheat, legume proteins, e.g. pea or chickpea, lupine, rice, canola, or mixtures of two or more thereof. Preferably the protein ingredient is sourced from plants, fungi, algae, or a mixture of two or more thereof.

In yet another aspect of the invention, the protein ingredient is present in a range of from 1.0 to 10.0 wt %, from 2.0 to 8.0 wt %, or from 3.0 to 5.0 wt % on the total weight of meat substitute product.

In one further aspect of the invention, the meat substitute product is further comprising one or more hydrocolloids. Hydrocolloids are polysaccharides of high molecular weight, extracted from plants, seaweeds or produced by microbial synthesis. Hydrocolloids are substances that form colloidal systems when dispersed in water. Examples of hydrocolloids are starches, xanthan gum, guar gum, locust bean gum, konjac gum, cellulose derivatives, alginate, pectin, carrageenan, gellan gum, agar, plant fibers or combinations of two or more thereof.

Starches may be from various botanical sources, such as potato starch or maize starch. They may be in form of native starch, physically or chemically modified starch, or a mixture of two or more thereof. Cellulose derivatives may be methyl cellulose, carboxymethyl cellulose and/or hydroxypropyl methylcellulose. Plant fibers may be citrus fiber, carrot fiber or chicory root fiber

The amount of each hydrocolloid, if present, is preferably in a range of from 0.1 to 3.0 wt %, from 0.2 to 2.5 wt %, or from 0.3 to 2.0 wt % on the total weight of the meat substitute product. Preferably, the one or more hydrocolloids are selected from the group consisting of starch, cellulose derivates, carrageenan, xanthan gum or fiber.

The one or more hydrocolloids may be added to the meat substitute product for their binding capacity and their ability for gelling during cooking of the meat substitute product. This may influence the moistness and succulence of the meat alternative product and may also influence the firmness of bite.

In another aspect of the invention, the meat substitute product comprises sodium chloride. The amount of sodium chloride is present in a range of from 0.1 to 3.0 wt %, from 0.2 to 2.5 wt %, from 0.5 to 2.0 wt %, or from 1.0 to 1.5 wt % on the total weight of meat substitute product.

In yet one more aspect of the invention, the meat substitute product comprises one or more ingredients selected from sodium ascorbates, citrates, sodium carbonates, sweeteners, flavoring agents, flavor enhancers, spices/seasonings and preservatives. The amount of each ingredient, if present, is preferably in a range of from 0.01 to 2.0 wt %, from 0.02 to 1.0 wt % on the total weight of the meat substitute product.

In one aspect of the invention, the meat substitute product is comprising:
a randomly interesterified triglyceride, and
at least one texturized protein ingredient, and
a protein ingredient, and
one or more hydrocolloids, and
   wherein the randomly interesterified triglyceride has:
a content of C16+C18 in a range of from 35 to 65 wt %, from 38 to 55 wt %, from 40 to 50 wt %, or from 42 to 45 wt %,
a ratio of C18 over C16 in a range of from 1.0 to 15.0, from 1.1 to 10.0, or from 1.2 to 8.0,
an SUS/SSU ratio in a range of from 0.5 to 1.0, from 0.6 to 0.9, or from 0.7 to 0.8, and wherein the meat substitute product is a ground meat substitute product, preferably a ground vegetarian protein product.

In one preferred aspect of the invention, the meat substitute product is comprising:
a randomly interesterified triglyceride in an amount of from 1.0 to 18.0 wt %, from 2.0 to 15.0%, from 4.0 to 12.5 wt %, or from 6.0 to 10.0 wt % on the total weight of the meat substitute product, and
at least one texturized protein ingredient in an amount if from 10 to 25 wt %, from 12 to 22 wt %, or from 15 to 20 wt %, expressed as dry weight on total weight of the meat substitute composition, and
a protein ingredient in an amount of from 1.0 to 10.0 wt %, from 2.0 to 8.0 wt %, or from 3.0 to 5.0 wt % on the total weight of meat substitute product, and
one or more hydrocolloids in an amount of each hydrocolloid, in an amount of from 0.1 to 3.0 wt %, from 0.2 to 2.5 wt %, or from 0.3 to 2.0 wt % on the total weight of the meat substitute product, and
   wherein the randomly interesterified triglyceride has:
a content of C16+C18 in a range of from 35 to 65 wt %, from 38 to 50 wt %, from 40 to 45 wt %,
a ratio of C18 to C16 of from 1.0 to 1.5, from 1.1 to 1.4,
an SUS/SSU ratio in a range of from 0.5 to 1.0, from 0.6 to 0.9, or from 0.7 to 0.8, and
   wherein the fatty acids from the randomly interesterified triglyceride are not sourced from palm and/or hydrogenated triglycerides,
   wherein the meat substitute product is a ground meat substitute product, preferably a ground vegetarian protein product.

In one more preferred aspect of the invention, the meat substitute product is comprising:
a randomly interesterified triglyceride in an amount of from 1.0 to 18.0 wt %, from 2.0 to 15.0%, from 4.0 to 12.5 wt %, or from 6.0 to 10.0 wt % on the total weight of the meat substitute product, and
at least one texturized protein ingredient in an amount if from 10 to 25 wt %, from 12 to 22 wt %, or from 15 to 20 wt %, expressed as dry weight on total weight of the meat substitute composition, and
a protein ingredient in an amount of from 1.0 to 10.0 wt %, from 2.0 to 8.0 wt %, or from 3.0 to 5.0 wt % on the total weight of meat substitute product, and
one or more hydrocolloids in an amount of each hydrocolloid, in an amount of from 0.1 to 3.0 wt %, from 0.2 to 2.5 wt %, or from 0.3 to 2.0 wt % on the total weight of the meat substitute product, and
   wherein the randomly interesterified triglyceride has:
a content of C12 of less than 5.0 wt %, less than 3.0 wt %, or even less than 1.0 wt %, a content of C16+C18 in a range of from 35 to 65 wt %, from 38 to 50 wt %, from 40 to 45 wt %,
a ratio of C18 to C16 of from 1.0 to 1.5, from 1.1 to 1.4,
an SUS/SSU ratio in a range of from 0.5 to 1.0, from 0.6 to 0.9, or from 0.7 to 0.8, and
   wherein the fatty acids from the randomly interesterified triglyceride are not sourced from palm and/or hydrogenated triglycerides,
   wherein the meat substitute product is a ground meat substitute product, preferably a ground vegetarian protein product.

In a most preferred aspect of the invention, the meat substitute product is comprising:
a randomly interesterified triglyceride in an amount of from 1.0 to 18.0 wt %, from 2.0 to 15.0%, from 4.0 to 12.5 wt %, or from 6.0 to 10.0 wt % on the total weight of the meat substitute product, and
a texturized protein ingredient in an amount if from 10 to 25 wt %, from 12 to 22 wt %, or from 15 to 20%, expressed as dry weight on total weight of the meat substitute composition, and
a protein ingredient in an amount of from 1.0 to 10.0 wt %, from 2.0 to 8.0 wt %, or from 3.0 to 5.0 wt % on the total weight of meat substitute product, and
one or more hydrocolloids in an amount of each hydrocolloid, in an amount of from 0.1 to 3.0 wt %, from 0.2 to 2.5 wt %, or from 0.3 to 2.0 wt % on the total weight of the meat substitute product, and
   wherein the randomly interesterified triglyceride has:
a content of C12 of less than 5.0 wt %, less than 3.0 wt %, or even less than 1.0 wt %,
a content of C16+C18 in a range of from 35 to 65 wt %, from 38 to 50 wt %, from 40 to 45 wt %,
a ratio of C18 to C16 of from 1.0 to 1.5, from 1.1 to 1.4,
an SUS/SSU ratio in a range of from 0.5 to 1.0, from 0.6 to 0.9, or from 0.7 to 0.8, and
   wherein the one or more hydrocolloids is selected from the group consisting of starch, cellulose derivates, carrageenan, xanthan gum or fiber, and
   wherein the fatty acids from the randomly interesterified triglyceride are not sourced from palm and/or hydrogenated triglycerides,
   wherein the meat substitute product is a ground meat substitute product, preferably a ground vegetarian protein product.

The meat substitute product according of the present invention that is comprising the randomly interesterified triglyceride, has an improved mouthfeel and texture compared to a meat substitute product that is comprising liquid oil and/or triglycerides that are not interesterified.

The specific melting behavior of the randomly interesterified triglyceride results in a meat substitute product of the present invention with a pleasant fatty and succulent mouthfeel. The meat substitute product has a good integrity during baking, frying and/or handling of the product.

The meat substitute product may be prepared in a process where the at least one texturized protein ingredient is hydrated and subsequently mixed with the rest of the dry ingredients and water in order to obtain a doughy product, i.e. the meat substitute dough. All steps for the preparation of the meat substitute dough are executed at a temperature below 8° C.

The meat substitute dough is subsequently shaped into a form, such as a burger, a patty, a meatball, a nugget, a sausage or the like. The shaped forms can be stored at 4° C., can be frozen at −18° C. or can be heat treated (like steam cooking, pan frying or oven baking) prior to storing at 4° C. or freezing at −18° C.

The invention relates to the use of the randomly interesterified triglyceride for improving the appearance, texture and/or organoleptic properties of a ground meat substitute product

The current invention relates to the use, wherein the randomly interesterified triglyceride has a content of palmitic acid (C16) and stearic acid (C18) in a range of from 35 to 65 wt %, from 38 to 55 wt %, from 40 to 50 wt %, or from 42 to 45 wt %, and a ratio of C18 over C16 is in a range of from 1.0 to 15.0, from 1.1 to 10.0, or from 1.2 to 8.0.

In one aspect, the current invention relates to the use, wherein the randomly interesterified triglyceride has a content of lauric acid (C12) of less than 5.0 wt %, less than 3.0 wt %, or even less than 1.0 wt %.

In another aspect, the current invention relates to the use, wherein the randomly interesterified triglyceride is characterized by a ratio of SUS over SSU (SUS/SSU) in a range of from 0.5 to 1.0, from 0.6 to 0.9, or from 0.7 to 0.8.

In one more aspect, the current invention relates to the use, wherein the randomly interesterified triglyceride has a content of oleic acid (C18.1) and linoleic acid (C18.2) in a range of from 35 to 60 wt %, from 40 to 58 wt %, or from 45 to 55 wt %.\

In yet another aspect, the current invention relates to the use, wherein the randomly interesterified triglyceride has a melting point in a range of from 35 to 65° C., from 38 to 55° C., or from 40 to 50° C.

In a preferred aspect, the current invention relates to the use, wherein the randomly interesterified triglyceride has:
a content of C16+C18 in a range of from 35 to 65 wt %, from 38 to 50 wt %, from 40 to wt %, and
a ratio of C18 to C16 of from 1.0 to 1.5, from 1.1 to 1.4, an SUS/SSU ratio in a range of from 0.5 to 1.0, from 0.6 to 0.9, or from 0.7 to 0.8, and
   wherein the fatty acids from the randomly interesterified triglyceride are not sourced from palm and/or hydrogenated triglycerides.

In a more preferred aspect, the current invention relates to the use, wherein the randomly interesterified triglyceride has:
a content of C16+C18 in a range of from 35 to 65 wt %, from 38 to 50 wt %, of from 40 to 45 wt %, and
a ratio of C18 to C16 of from 1.0 to 1.5, from 1.1 to 1.4, and
a content of C12 of less than 5.0 wt %, less than 3.0 wt %, or even less than 1.0 wt %, and
a content of C18.1+C18.2 in a range of from 35 to 60 wt %, from 40 to 58 wt %, or from 45 to 55 wt %,
an SUS/SSU ratio in a range of from 0.5 to 1.0, from 0.6 to 0.9, or from 0.7 to 0.8, and
   wherein the fatty acids from the randomly interesterified triglyceride are not sourced from palm and/or hydrogenated triglycerides.

### EXAMPLES

### 1. The Randomly Interesterified Triglyceride

Randomly interesterified triglycerides No 1 to 5 are obtained by chemically interesterifying the fat blends 1 to 5 as described in table 1. The chemical interesterification is a process that is generally well known by the person skilled in the art.

The fatty acid composition of the randomly interesterified triglycerides are shown in table 1.

TABLE 1
Composition of the fat blends & fatty acid composition
of the randomly interesterified triglycerides

| | | | | |
|---|---|---|---|---|
| No 1 | No 2 | No 3 | No 4 | No5 |

Composition of the fat blends

| | | | | | |
|---|---|---|---|---|---|
| Cocoa butter | 70 | 70 | | 57 | |
| Shea Butter | | | 80 | | |
| Shea olein | | | | 27 | 60 |
| Fully | | | | | 20 |
| hydrogenated | | | | | |
| sunflower oil | | | | | |
| Rapeseed oil | 30 | | | 16 | 20 |
| Sunflower oil | | | 20 | | |
| Coconut oil | | 30 | | | |

Fatty acid composition of the randomly interesterified triglycerides

| | | | | | |
|---|---|---|---|---|---|
| C12 | 0.0% | 12.8% | 0.0% | 0.1% | 0.2% |
| C16 | 18.8% | 20.4% | 3.8% | 16.6% | 5.8% |
| C18 | 25.1% | 26.5% | 37.7% | 28.2% | 36.1% |
| C16 + C18 | 43.9% | 46.9% | 41.6% | 44.7% | 41.9% |
| C18/C16 | 1.3 | 1.3 | 9.8 | 1.7 | 6.2 |
| C18.1 | 42.7% | 26.7% | 46.3% | 44.1% | 44.8% |
| C18.2 | 7.9% | 3.1% | 7.9% | 7.3% | 9.2% |
| C18.1 + C18.2 | 50.6% | 29.8% | 54.1% | 51.4% | 53.9% |

Positional triglyceride composition of the
randomly interesterified triglycerides

| | | | | | |
|---|---|---|---|---|---|
| DAG | 1.9 | 1.3 | 2.1 | 2.1 | 2.1 |
| SSS | 10.4 | 39.6 | 6.6 | 10.3 | 7.4 |
| SUS | 11.6 | 13.8 | 9.6 | 11.5 | 10.1 |
| SSU | 23.1 | 27.6 | 19.3 | 23.0 | 20.2 |
| SUU | 25.5 | 9.6 | 27.9 | 25.7 | 27.5 |
| USU | 12.7 | 4.8 | 14.0 | 12.9 | 13.8 |
| UUU | 14.1 | 1.7 | 20.3 | 14.4 | 18.8 |
| SUS/SSU | 0.5 | 0.5 | 0.5 | 0.5 | 0.5 |

### 2. Recipe of the Meat Substitute Product

Food products are prepared.

The recipe of the meat substitute products is shown in table 2.

TABLE 2
Recipe of the meat substitute product

| | Recipe A | | |
|---|---|---|---|
| | (comparative | | |
| | example) | Recipe B | Recipe C |
| Water to hydrate texturized | 50% | 50% | 50% |
| protein | | | |
| Texturized pea protein | 20% | 20% | 20% |
| Water | 9.6% | 9.6% | 9.6% |
| Pea protein isolate | 5.0% | 5.0% | 5.0% |
| Methylcellulose | 0.65% | 0.65% | 0.65% |
| Carrageenan (Satiagel RPM 64 | 1.75% | 1.75% | 1.75% |
| R2 from Cargill) | | | |
| Starch* (SimPure 99400) | 1.0% | 1.0% | 1.0% |
| Citrus fiber | 0.5% | 0.5% | 0.5% |
| Salt | 1.0% | 1.0% | 1.0% |
| Rapeseed oil | 2% | 2% | 2% |
| Coconut oil | 8.5% | | |
| Randomly interesterified | | 8.5% | |
| triglyceride No 1 | | | |
| Randomly interesterified | | | 8.5% |
| triglyceride No 2 | | | |

*Starch SimPure 99400 from Cargill: a label friendly functional native starch.

### 3. Preparation of the Meat Substitute Product

The following steps are taken to prepare the meat substitute product according to the present invention:
The fat (randomly interesterified triglyceride No 1, No 2 or coconut oil) in powdered form is prepared:
   Cubes (about 1 to 2 cm³) of the fat are kept for at least 12 h at −18° C.
   The cubes of fat in frozen condition are crushed into a Thermomix for 10 seconds at maximum speed.
   Resulting fat in powdered form is kept in frozen condition.
The texturized proteins are well hydrated.
The dry ingredients of the recipe and the water are mixed with the hydrated texturized proteins.
The rapeseed oil and the powdered fat are added to the rest of the ingredients and mixed. A meat substitute product dough is obtained.
The meat substitute product dough is shaped in the form of burgers of 100 gram.
The burgers are cooked in an oven at 100° C. with 100% steam. The internal temperature of the burgers must be above 75° C.
The burgers are cooled and stored at 4° C.

1. A meat substitute product comprising a randomly interesterified triglyceride, and at least one texturized protein ingredient, wherein the randomly interesterified triglyceride has a content of palmitic acid (C16) and stearic acid (C18) in a range of from 35 to 65 wt %, and a ratio of C18 over C16 in a range of from 1.0 to 15.0.

2. The meat substitute product according to claim 1, wherein the randomly interesterified triglyceride has a content of lauric acid (C12) of less than 5.0 wt %.

3. The meat substitute product according to claim 1, wherein the randomly interesterified triglyceride has a content of oleic acid (C18.1) and linoleic acid (C18.2) in a range of from 40 to 65 wt %.

4. The meat substitute product according to claim 1, wherein the randomly interesterified triglyceride has an SUS/SSU ratio in a range of from 0.5 to 1.0.

5. The meat substitute product according to claim 1, wherein the randomly interesterified triglyceride is present in an amount of from 1.0 to 18.0 wt % on the total weight of the meat substitute product.

6. The meat substitute product according to claim 1, wherein the meat substitute product has a total triglyceride content in a range of from 2.0 to 25.0 wt % on the total weight of the meat substitute product.

7. The meat substitute product according to claim 1, wherein the meat substitute product is further comprising a liquid oil in an amount of from 1.0 to 7.0 wt % on the total weight of the meat substitute product.

8. The meat substitute product according to claim 1, wherein the at least one texturized protein ingredient is present in an amount of from 10 to 25 wt %, expressed as dry weight on total weight of the meat substitute composition.

9. The meat substitute product according to claim 1, wherein the meat substitute product is a ground meat substitute product.

10. The meat substitute product according to claim 1, wherein the meat substitute product is a ground vegetarian protein product.

11. The meat substitute product according to claim 1, wherein the meat substitute product is a pet food.

12-15. (canceled)
